(19) United States
(12) Patent Application Publication
(10) Pub. No.: US 2026/0281128 A1
(43) Pub. Date: Sep. 17, 2026

(54) A METHOD AND SYSTEM FOR CALLER RISK SCORING USING STIR/SHAKEN DATA

(71) Applicant: Vail Systems, Inc., Deerfield, IL (US)

(72) Inventors: Srinivasa C RAO, Schaumburg, IL (US); Todd WHITELEY, Lake Forest, IL (US); Bopsi CHANDRAMOULI, Palatine, IL (US); David James FRUIN, La Grange Park, IL (US)

(73) Assignee: Vail Systems, Inc., Deerfield, IL (US)

(21) Appl. No.: 19/169,273

(22) Filed: Apr. 3, 2025

Related U.S. Application Data
(60) Provisional application No. 63/631,773, filed on Apr. 9, 2024.

(51) Int. Cl. H04L 9/40; H04M 3/22; H04M 3/42

(52) U.S. Cl. CPC H04L 63/1416; H04M 3/2281; H04M 3/42059

(57) ABSTRACT

Methods, systems, and non-transitory computer-readable medium are provided for caller risk scoring using STIR/SHAKEN data. A network fraud detection engine receives attestation and verification status data from a real-time telephony network signaling system and retrieves historical STIR/SHAKEN data from a call authentication database. Attestation-verification pairings are categorized into predefined resolved values, and a caller risk score is computed based on frequency, recency, and contiguity analysis. A weighted risk model applies an appropriate decay function and amplifies contiguous spans of directionally similar values. The computed caller risk score is then transmitted to a service platform for call handling, fraud detection, and routing decisions. The system dynamically adjusts thresholds using machine learning-driven fraud pattern recognition, ensuring adaptive real-time filtering of high-risk inbound calls. This solution enhances telephony security while reducing false positives for legitimate calls.

### CROSS-REFERENCE TO RELATED APPLICATIONS

This application claims priority to and the benefit of U.S. Provisional Patent Application No. 63/631,773, filed Apr. 9, 2024, which is hereby incorporated herein in its entirety.

### TECHNICAL FIELD AND BACKGROUND OF THE DISCLOSURE

The present disclosure relates generally to a system, apparatus, and computer-implemented method for caller risk scoring based on STIR/SHAKEN data, including, but not limited to, assigning and applying quantitative risk scoring to incoming telephone calls based on STIR/SHAKEN data.

The present disclosure also relates to telephony systems, specifically to the objective of assigning a quantitative measure of risk to each inbound call, so that appropriate call treatment may be applied to the inbound call by the service platform.

In 2016, the Federal Communications Commission (FCC) created the Robocall Strike Force to explore ways to identify spam calls and caller identification (ID) spoofing that are the primary means by which various types of fraud is conducted via the telephony channel. This initiative resulted in a new protocol called STIR/SHAKEN which is an acronym for “Secure Telephone Identity Revisited/Signature-based Handling of Asserted Information Using toKENs). Briefly, this new protocol allows carriers to provide trust information about calls originating on their network so that the authenticity of the caller ID provided by callers may be later verified by the receiving carrier networks. The trust information is provided via attestations and the protocol specifies the various attestation categories and their meanings. The protocol however does not specify how attestations should be computed by carriers. This results in considerable variations in how different carriers compute the attestations-leaving downstream service providers without any knowledge of how reliable and deterministic the upstream attestations are. Because of this, fraud detection solutions that depend on upstream attestations are likely to be incomplete and unreliable to an indeterminate degree. A method and system are provided for assessment of risk associated with an inbound call by analyzing the STIR/SHAKEN data associated with that call against all available historical STIR/SHAKEN data for that calling number.

Call handling policies require an estimate of the risk associated with incoming calls before those calls are answered. A number of state-of-the-art methodologies for detecting fraud in telephone systems, including those described in U.S. Pat. Nos. 10,091,349 and 10,477,012, each titled “Fraud Detection System and Method”, and 10,623,581, titled “Adaptive, Muli-Modal Fraud Detection System,” each of which is hereby incorporated herein by reference.

### SUMMARY OF THE DISCLOSURE

The instant disclosure provides an innovative technological solution for caller risk scoring based on STIR/SHAKEN data, including, but not limited to, assigning and applying quantitative risk scoring to incoming telephone calls based on STIR/SHAKEN data. The technological solution includes a computer-implemented method, a non-transitory computer storage medium, and a system.

The technological solution provides a novel methodology for analyzing, among other things, STIR/SHAKEN data and calculating a caller risk score associated with incoming calls before those calls are answered. The solution overcomes specific, inherent shortcomings of the STIR/SHAKEN protocol in assessing caller risks.

The disclosed system enhances real-time inbound call handling efficiency by integrating dynamic fraud risk scoring directly into network-based call authentication systems, such as SIP proxy servers, telephony analytics modules, or carrier fraud detection nodes. Unlike conventional fraud detection solutions that rely on static, carrier-generated attestations, the disclosed system continuously analyzes real-time call routing behavior, carrier reliability patterns, and historical STIR/SHAKEN attestations to produce adaptive caller risk scores. These scores allow for optimized call handling decisions, ensuring that low-risk calls are processed with minimal latency while high-risk calls trigger automated authentication safeguards or routing restrictions.

In various embodiments, the technological solution includes applying frequency, recency, and contiguity to historical and immediate STIR/SHAKEN data, allowing for computation of risk associated with inbound telephone calls from non-deterministic and, potentially, unreliable STIR/SHAKEN data presented by the inbound calls.

Since the STIR/SHAKEN protocol does not specify how attestations should be computed, considerable variations result in how different carriers provide attestations. There currently exists no practical way to identify the degree of unreliability in the provided attestations, in assessing inbound caller risk. The technological solution of the instant disclosure provides an innovative solution to overcome this problem. Indeed, the technological solution is able to compute a reliable risk score regardless of the degree of uncertainty in the accuracy of the input STIR/SHAKEN attestations, such as, for example, provided by originating carriers.

Unlike conventional fraud detection techniques that rely solely on static rule-based filtering or carrier-generated attestations, the present disclosure introduces a dynamically adaptive caller risk scoring system that operates in real time and incorporates historical STIR/SHAKEN data analytics to improve call handling efficiency. The disclosed system leverages a weighted multi-factor approach that adjusts risk scores based on a combination of frequency, recency, and contiguity of attestation-verification pairings, allowing for a more granular and adaptive risk assessment model. This approach significantly reduces false positives and ensures that legitimate calls are not inadvertently blocked due to unreliable upstream attestation data. Furthermore, the disclosed system interfaces directly with network-based fraud prevention engines, enabling real-time adaptive call filtering that continuously improves its accuracy based on real-world call patterns.

In at least one embodiment, the technological solution includes telephone network forensics to determine validity of a calling number.

In another embodiment, the technological solution includes audio analysis for determining the provenance of incoming calls.

In yet another embodiment, the technological solution includes analysis of call metadata.

In a further embodiment, the technological solution includes creating a crowd-sourced database of calling numbers that are determined to be involved in robocalling, fraud, or other problematic activity. The technological solution includes using the database to assign high risk scores to call originating from numbers in the database.

According to an aspect of the disclosure, a method is provided for determining caller risk scoring using STIR/SHAKEN data. The method includes receiving, by a fraud detection engine, STIR/SHAKEN attestation and verification status data associated with an inbound call from a real-time telephony network signaling system. The fraud detection engine retrieves historical STIR/SHAKEN data associated with a calling number from a call authentication database and categorizes attestation-verification pairings into a predefined set of resolved values comprising Pass-A, Pass-B, Pass-C, Fail, and None. A consistency rating for the calling number is computed by applying weighting factors to the attestation and verification data based on at least one of a frequency of prior occurrences, a recency-based decay factor applied to historical data, and a contiguity analysis of directionally similar attestation-verification pairings. A caller risk score for the inbound call is determined based on the computed consistency rating, and the caller risk score is output to a service platform for call treatment.

The method further includes applying an appropriate decay function for computing the weights to be applied to the historical STIR/SHAKEN data, allowing for higher significance to recent STIR/SHAKEN data and lesser significance to remote STIR/SHAKEN data. The choice of such a decay function is part of the system configuration and includes a built-in set of decay functions to choose from, such as a Null Decay Function, Linear Decay Function, Stepped Decay Function, Geometric Decay Function, and a Power Decay Function. The caller risk score is further adjusted based on a dynamic fraud intelligence feed. A higher weight is assigned to contiguous spans of directionally similar attestation-verification values when computing the consistency rating. The predefined set of resolved values is computed by mapping each attestation-verification pairing to a corresponding numeric value and assigning a weight to the numeric value based on its position within the set of historical numeric values, with the computation of the weight performed using an appropriately chosen decay function. The computed caller risk score is stored in a database for future reference and is transmitted to a third-party fraud prevention service for call handling.

The disclosure further provides a system for caller risk scoring using STIR/SHAKEN data. The system includes a processor configured to receive STIR/SHAKEN attestation and verification status data associated with an inbound call, retrieve historical STIR/SHAKEN data associated with a calling number, categorize attestation-verification pairings into a predefined set of resolved values comprising Pass-A, Pass-B, Pass-C, Fail, and None, compute a consistency rating for the calling number by applying weighting factors to the attestation and verification data based on at least one of a frequency of prior occurrences, a recency-based decay factor applied to historical data, and a contiguity analysis of directionally similar attestation-verification pairings, determine a caller risk score for the inbound call based on the computed consistency rating, and output the caller risk score for application to call handling policies. The system further includes a storage medium storing historical STIR/SHAKEN data and attestation-verification pairings, and a communication interface configured to transmit the caller risk score to at least one service provider.

The processor is further configured to apply an appropriate decay function selected from a set of built-in decay functions within the SSAM, as the recency-based decay adjustment to historical STIR/SHAKEN data values. The processor is also configured to adjust the caller risk score based on a real-time fraud intelligence feed. The processor assigns a higher weight to contiguous spans of directionally similar attestation-verification values when computing the consistency rating and maps each attestation-verification pairing to a corresponding risk weight based on predefined threshold values. The storage medium stores previously computed caller risk scores for future reference. The communication interface transmits the computed caller risk score to a fraud detection service for call treatment.

The present disclosure further provides a non-transitory computer-readable medium storing instructions that, when executed by a processor, cause a computing device to perform operations comprising receiving STIR/SHAKEN attestation and verification status data associated with an inbound call, retrieving historical STIR/SHAKEN data associated with a calling number, categorizing attestation-verification pairings into a predefined set of resolved values comprising Pass-A, Pass-B, Pass-C, Fail, and None, computing a consistency rating for the calling number by applying weighting factors to the attestation and verification data based on at least one of a frequency of prior occurrences, a recency-based decay factor applied to historical data, and a contiguity analysis of directionally similar attestation-verification pairings, determining a caller risk score for the inbound call based on the computed consistency rating, and outputting the caller risk score to a service platform for call treatment.

The instructions further cause the computing device to apply a chosen decay function as the recency-based decay adjustment to historical STIR/SHAKEN data values. The instructions cause the computing device to adjust the caller risk score based on real-time fraud intelligence data and assign a higher weight to contiguous spans of directionally similar attestation-verification values when computing the consistency rating. The computing device stores computed caller risk scores for future reference and transmits the computed caller risk score to a fraud prevention system for call handling.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an example of a process for implementing the STIR/SHAKEN protocol.

FIG. 2 shows a nonlimiting example a table containing enumeration of fully resolved attestation-verstat pairings, their assigned values, corresponding weight factors applicable to those values, and the weighted values of the fully resolved attestation-verstat pairings.

FIG. 3 shows a nonlimiting example of a table wherein an embodiment of an SSAM implementation with a decay factor of 0.95 applied to the weighting factors in FIG. 2.

FIG. 4 shows a nonlimiting example of a table containing computations according to a nonlimiting embodiment of the disclosure.

FIG. 5 shows a nonlimiting embodiment of a process for caller risk scoring, according to the principles of the disclosure.

FIG. 6 shows a nonlimiting embodiment of a system for caller risk scoring, according to the principles of the disclosure.

The present disclosure is further described in the detailed description that follows.

### DETAILED DESCRIPTION

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

The deregulation of the telecom industry coupled with the rise of VOIP (Voice-Over-Internet-Protocol) has caused the traditional telephony network to be exposed to technologies that it was not originally designed for. This includes the ability to spoof caller IDs, and to launch large-scale attacks through automated telephony applications. This has resulted in a dramatic increase in telephony-based fraud along with an explosive growth in robocalls in recent years. It is estimated that close to 80 billion robocalls have been made in the USA in the year 2022 alone. The single biggest attack vector within telephony related fraud is therefore the origination of robocalls using spoofed calling numbers.

The STIR/SHAKEN protocol allows carriers to provide trust information about calls originating on their network (attestations) so that the authenticity of the caller ID provided by callers may be verified by the receiving carrier network and thus be able to certify the result of the verification action with corresponding additional data known as verification status data or verstat data.

The Telephone Robocall Abuse Criminal Enforcement and Deterrence Act (TRACED) requires the adoption of the STIR/SHAKEN framework by telecommunication companies. The FCC has mandated that all voice service providers implement STIR/SHAKEN protocols. The STIR/SHAKEN framework requires the originating carriers to provide the level of trust (attestation) about the authenticity of the calling party. The attestations may include any of the following values:
(A) Full Attestation: The calling party is known and is authorized to use the calling number.
(B) Partial Attestation: The originating carrier has authenticated that the call originates from the carrier's network but cannot verify that the calling party is authorized to use the calling number.
(C) Gateway Attestation: The originating carrier has authenticated from where the call was received but cannot authenticate the source of the call.

While STIR/SHAKEN is a step in the right direction for identifying caller ID spoofing, it has several limitations that restrict its applicability, including:
STIR/SHAKEN is applicable only to IP technology and does not work on legacy telephone networks. This means that the benefits of the protocol are lost whenever calls traverse from IP network over to non-IP networks and vice versa. For this reason, a significant percentage of telephone calls at the present time do not carry STIR/SHAKEN attestations-making the solution an incomplete one.
The STIR/SHAKEN protocol mandate only applies to US carriers. So, all international calls fall outside of its scope. At the present time, this technology is not widely implemented outside of the USA.

The attestation levels determined by the originating carrier are based on the carrier's knowledge and verification processes of their customers. Different carriers have their own policies, guidelines, and implementations of the protocol-resulting in possible impedance mismatch of the attestations generated at the originating carrier with those of the verifications done at the terminating carrier.
There are 3 attestation levels that may be assigned. Only attestation A may be considered definitive. Further, a significant portion of calls carry the non-definitive B & C attestations and need to be subjectively handled by the terminating carrier depending on the call context and also the policies and implementation of the STIR/SHAKEN protocol at their end.
The various attestation levels only indicate how sure the originating carrier is of the lawful utilization of the calling number for any initiated call. An attestation level does not indicate what the calling individual's identity is, or of the intention of the caller.
Calls with the highest levels of attestation may still be robocalls from authorized entities (e.g., surveys, political campaigns, etc.), fraudulent in intent, or otherwise undesirable, from the called party's point of view.

From all the aforementioned limitations, it is easy to see why the STIR/SHAKEN protocol is not the silver bullet that telephony service providers can just implement uniformly for all of their call handling decisions. As of the date of this writing, a significant portion of call traffic do not have any attestations. Of those that do, a significant portion are either level B, or level C attestations-which are non-definitive. Certainly, the STIR/SHAKEN framework helps reduce the robocalling problem, but it does not address the entirety of the call flow scenarios which also involve a variety of fraud vectors that fall outside the domain of robocalling. This is a huge problem for many businesses which cannot simply block customers just because they do not have an attestation, or because they have an insufficient level of attestation.

This disclosure provides a technological solution for assigning the level of risk that may be associated with any incoming call, so that appropriate call handling policies may be applied. The solution addresses the specific aspect of the non-deterministic nature of upstream STIR/SHAKEN attestations and how such non-deterministic data may be used in the assessment of risk associated with inbound calls.

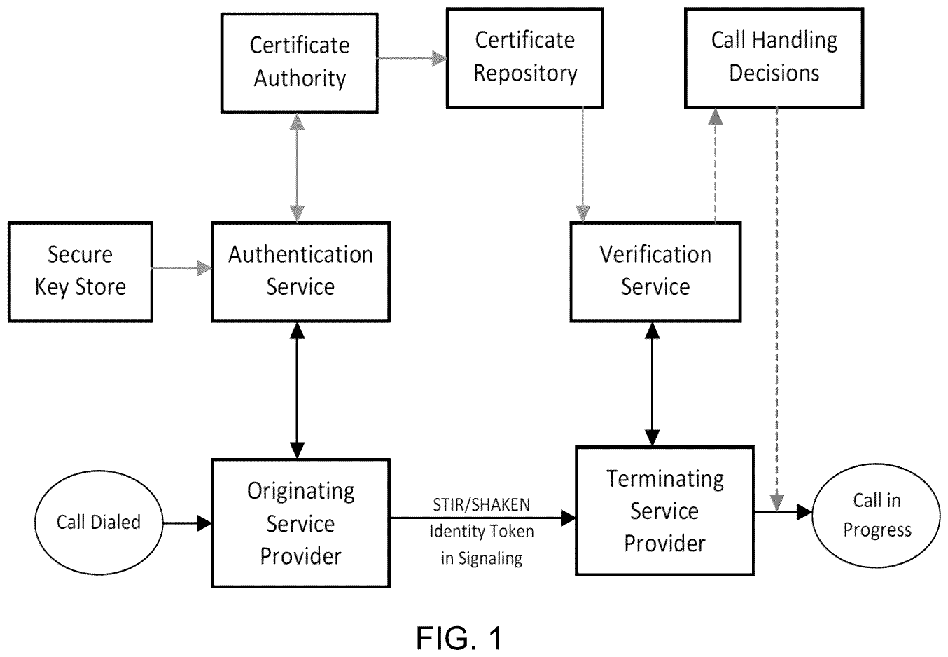

FIG. 1 shows an example of a process for implementing the STIR/SHAKEN protocol.

A STIR/SHAKEN Analytics Module (SSAM) is responsible for examining the STIR/SHAKEN attestation data provided by the originating telephony network and the corresponding verification data provided by the terminating telephony network (verstat data) associated with the current call for immediate authentication purposes, as well as analyzing the historical STIR/SHAKEN data associated with the caller for additional analytics.

When a call is dialed, the originating service provider (OSP) needs to check and attest for the validity of the calling number being used. If the OSP is able to authenticate the calling party and that they are authorized to use that calling number, attestation level will be A. If the OSP is able to authenticate the calling party but cannot verify if the caller is authorized to use the calling number, attestation level will be B. If the OSP can verify the source of the call, but cannot authenticate the identity of the caller, attestation level will be C.

Once the attestation level is determined, the OSP uses an Authentication Service (AS) to create a SIP Identity header containing the calling number, the called number, date & time, attestation, and a unique originating identifier. This information is signed using the OSP's private key is encrypted & stored in the Secure Key Store. The public key needed by other parties to verify the OSP's signature is exposed via a certificate obtained from a Certificate Authority (CA), and stored in the Certificate Repository (CR). When the call arrives at the Terminating Service Provider (TSP), the TSP obtains the OSP's certificate from the Certificate Repository, verifies it using the CA, and uses the public key to verify the OSP's signature. Once verified, the information in the Identity Header is used to read the attestation & other details. The TSP then generates a verification status value called verstat that is placed into the signaling data and the call is handled based on the attestation & verstat values in the signaling data.

The various attestation levels having already been described, the verstat values may be one of the following values.
TN-Validation-Passed: The Identity Token has passed verifications.
TN-Validation-Failed. One or more verification steps have failed.
No-TN-Validation. There is no attestation data available that can be verified.

It is quite possible that by the time the SIP INVITE has arrived at the Terminating Service Provider (TSP), the Terminating Carrier (TC) had already done the verification, and placed the verstat value in the SIP INVITE. If the TSP wishes to override the TC's verification process and compute their own verstat, it is perfectly acceptable to implement a custom Verification Service providing a desired custom implementation. This aspect of STIR/SHAKEN implementations being affected by an impedance mismatch had already been mentioned earlier. Regardless of whether a carrier's verstat is used, or whether that has been overridden by the TSP's own verstat, the enumeration of the verstat remains effectively as being one of the previously enumerated values.

In various embodiments, the method includes a systematic method for analyzing the STIR/SHAKEN data presented by an inbound telephone call along with historical STIR/SHAKEN data available for the calling number in question. The analytics applied to the data aim to identify patterns within the historical data and assign quantitative measures of risk associated with those patterns.

The algorithm for these analytics is described below. For purposes of the following description, the implementation of this algorithm can be provided, for example, as a software module called STIR/SHAKEN Analytics Module (SSAM).

In the embodiments, the method first retrieves the historical STIR/SHAKEN data for the calling number of the current call for a certain time period extending into the past from the time of the current inbound call. This is typically about six (6) months but may be either increased or decreased as necessary in any given implementation.

Each historical STIR/SHAKEN record will yield an attestation value (A/B/C) and a verstat value (Verified/Failed/None). For each retrieved record, if verification was successful (verstat=TN-Validation-Passed), the method accepts the A, B, C values as Pass-A, Pass-B, and Pass-C—all of them are positive results of different intensity. If verification failed (verstat=TN-Validation-Failed), then, the attestation has no meaning, but the record yields a negative result since it indicates a failure to authenticate. If verification could not be done at all (verstat=No-TN-Validation) because there was no attestation to start with, or because the verification process failed, then, it is as if STIR/SHAKEN had no role to play in the scenario in question, and the record may be ignored for purposes of STIR/SHAKEN analytics.

The combined attestation & verstat values may effectively be reduced to the following authentication results:
Pass-A
Pass-B
Pass-C
Fail
None

The Pass-A, Pass-B, and Pass-C values are distinct values, but are directionally similar as they indicate different degrees of positive attestation. The Fail value is a distinct value, and is directionally opposite to the above 3 pass values. The None value is directionally neutral and has zero value. Hence, in this embodiment, the method has 5 distinct values that fall into 3 different groups, each group having a different directionality.

The SSAM looks at the historical STIR/SHAKEN results from 3 different viewpoints for a determination of the consistency of the STIR/SHAKEN results:
(1) Frequency: The count of a specific result (listed above) within any given time period. The incidence of each distinct result indicates the weight or relevance of that result.
(2) Recency: The more recent results tend to be more significant than the farther-out or remote results. The proximity of a result to the current inbound call (on the time axis) is assigned higher weight compared to a similar result farther away in the past.
(3) Contiguity: Contiguous spans of directionally similar results are more significant than interleaved or scattered results. The results within clusters of directionally similar values reinforce each other within the cluster and hence increase the importance given to the cluster based on its size.

The SSAM assigns specific numeric values to each of the combined attestation & verstat pairs enumerated earlier. These assignments are typically within the SSAM system configuration, and may be adjusted as necessary in different application scenarios.
Pass-A (+1.0)
Pass-B (+0.5)
Pass-C (+0.2)
Fail (−1.0)
None (0.0)

The predefined threshold values for attestation-verification risk mapping are determined based on historical fraud trends, industry best practices, and real-time risk assessment data. In one non-limiting embodiment, the predefined threshold values for caller risk classification are as follows:
High Risk (e.g., ≥80): Calls with a computed risk score of 80 or higher are classified as high risk and may be automatically blocked, redirected, or subjected to multi-factor authentication before call completion.
Moderate Risk (e.g., 50-79): Calls with a computed risk score between 50 and 79 are classified as moderate risk and may be flagged for additional verification, such as real-time audio analysis, caller authentication, or human review before allowing the call to proceed.
Low Risk (e.g., <50): Calls with a risk score below 50 are considered low risk and can be processed normally without additional verification.

The listed predefined threshold values are provided as non-limiting examples solely for illustration and a person having ordinary skill in the art would understand that these threshold values may be varied as appropriate. Also, the predefined threshold values may be dynamically adjusted over time based on machine learning-driven fraud pattern recognition and regulatory compliance requirements. In some embodiments, the threshold values may be configured by network administrators to account for specific business needs or evolving fraud patterns.

Additionally, certain high-risk call patterns may trigger automated safeguards, including but not limited to: Blacklisting of repeat fraudulent numbers when risk scores exceed a configurable threshold (e.g., 95 or higher); Real-time voice authentication challenges for numbers with inconsistent attestation histories; and/or Temporary call blocking or manual review escalation for calls that exhibit rapid recurrence from previously flagged numbers.

By incorporating these threshold-based risk categories, the disclosed system ensures actionable and adaptive call handling policies, reducing both false positives (blocking legitimate calls) and false negatives (allowing fraudulent calls).

In one non-limiting example, the caller risk score (RS) can be computed as follows:

$$R S = {\sum }_{i = 1}^{n} W i \times V i$$

where Wi represents a weight factor assigned to each attestation-verstat pair (e.g., Pass-A: 1.0, Pass-B: 0.5, Pass-C: 0.2, Fail: −1.0) and Vi represents a historical occurrence count of each attestation-verstat pair over a rolling six-month window.

The weights can be dynamically adjusted based on a decay function that is appropriate to a data series. The purpose of the decay function is to cause a gradual reduction in the weights of the remote (farther away) values. The choice of an appropriate decay function can be made depending on the application context and requirements. Examples of decay functions include a Null Decay Function which maintains the weights of all values at 1.0, a Stepped Decay Function that assigns fixed weights to different value ranges, a Linear Decay Function that allows the weights to vary linearly from 1.0 for the most recent value to a minimum weight for the most remote value, a Geometric Decay Function which applies a fixed decay factor to each weight to yield the next weight as we move from the most recent to the most remote values, or a Power Decay Function that can represent any desired smooth decay behavior.

The representations for the various decay function within the SSAM are as follows. We assume here that the data series contains N values arranged from the most recent to the most remote, and that we are computing the weight factor for a value at the i-th position in the set of values.

### Null Decay Function:

$$W ( i ) = ( fixedWeight ) for i = 0 to N - 1$$

### Stepped Decay Function:

$$i -- > Step -- > W ( Step ) for i = 0 to N - 1$$

### Linear Decay Function:

$$W ( i ) = ( minWeight + ( maxWeight - minWeight ) * \frac{( N - 1 )}{} N ) for i = 0 to N - 1$$

### Geometric Decay Function:

$$W ( i ) = pow ( DecayFactor , i ) for i = 0 to N - 1$$

### Power Decay Function:

$$W ( i ) = ( 1.0 - p o w ( ( 1 + k * i ) , p ) ) for i = 0 to N - 1$$

where k and p are parameters defining the power decay function.

The weights can be dynamically adjusted based on a decay function, such as exponential decay (λe−λt), where λ represents a decay constant that determines the rate at which historical values lose influence over time, with t representing the time elapsed since the original attestation-verstat pairing was recorded.

Contiguous spans of directionally similar attestation-verstat pairs can be amplified by a contiguity factor C, such that:

$$RSfinal = RS + ( C \times RSspan )$$

where RSspan is an aggregated risk score of contiguous attestation-verstat pairs, and C is an amplification factor that increases based on the length of the span, establishing higher risk for consistent patterns of fraudulent behavior.

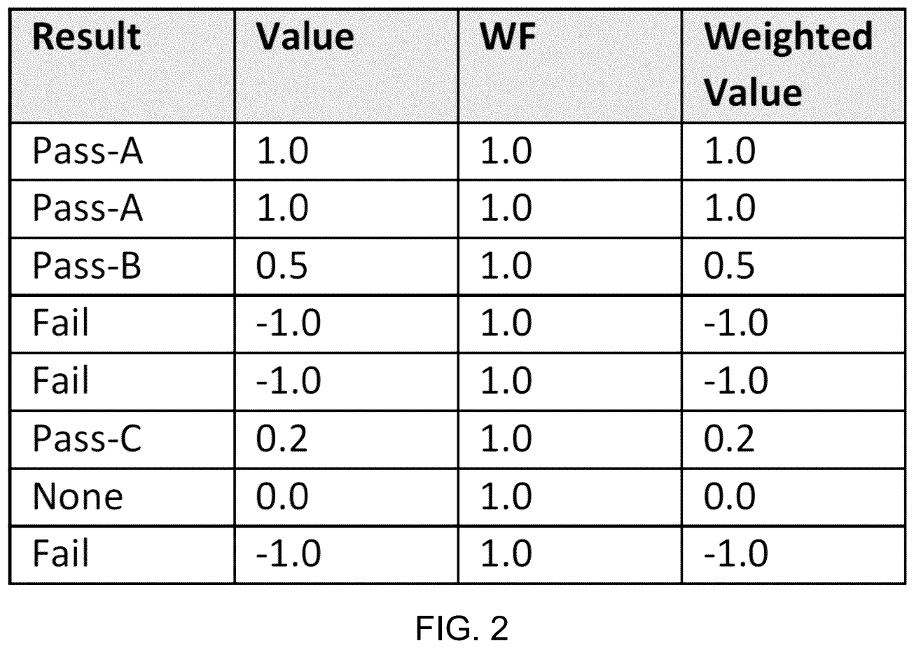

For purposes of illustration, FIG. 2 shows a nonlimiting example a table containing enumeration of fully resolved attestation-verstat pairings, their assigned values, corresponding weight factors applicable to those values, and the fully weighted values of the fully resolved attestation-verstat pairings. All values are initially assumed to have equal weight (WF=1.0)—i.e., all historical values have the same weight regardless of how recent or remote they are.

The sum of the adjusted pass values is +2.7, the sum of the adjusted fail values is −3.0. Hence the overall result is −0.3. The consistency of the data set is −0.3/7=−4.28%. Note that the None value is ignored as an item, and the count of items is 7.

The system and methodology rely on the notion of recency being important to apply weights that are adjusted to the recency of each value to the values in the data. A number of possible decay functions, as described above, can be made available within the current system. An application is free to choose the appropriate decay function based on its specific requirements.

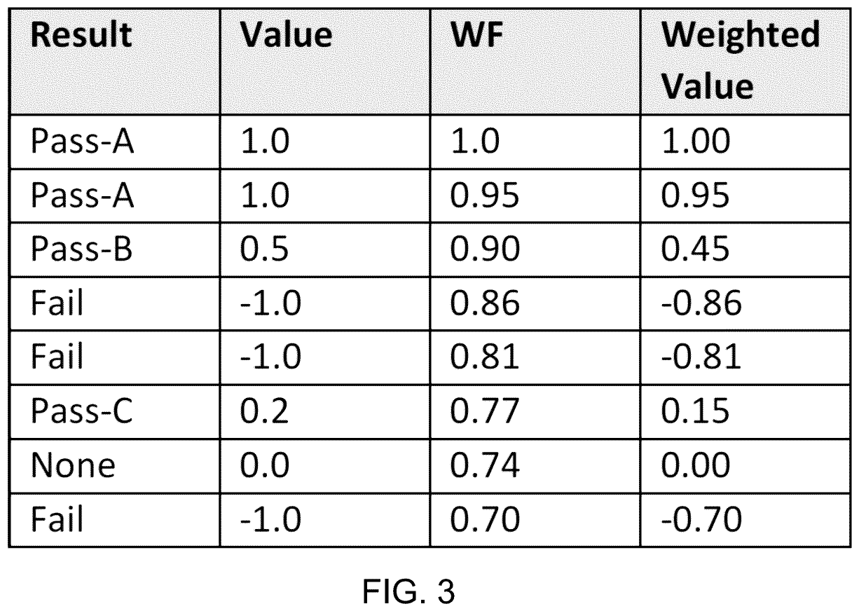

For purposes of illustration, an SSAM implementation uses an exemplary geometric decay function with an exemplary decay factor of 0.95, as shown in FIG. 3. With this decay factor, the weight factors (WF) in the table shown in FIG. 2 are adjusted as shown in the table in FIG. 3.

Referring to FIG. 3, in a non-limiting embodiment, the sum of all the adjusted pass values can be +2.55, and the sum of all the adjusted fail values can be −2.37. Hence the overall result is +0.18. The consistency of the data set is 0.18/7=2.57%. Note that the None value can be ignored as an item, and the count of items can be 7.

Considering the notion of contiguity of similar values being important, additional embodiments can be further modified as follows.

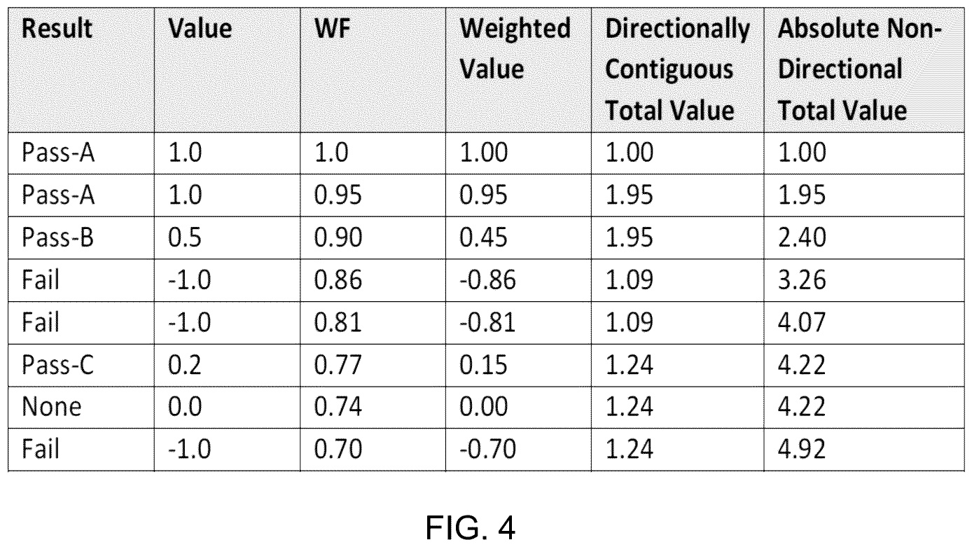

Starting with the first item, its value is noted, and the next item is considered. If that next item has the same directionality, then the first item is counted in. The second item would count only if the third item has the same direction as the second item. As soon as an item is considered with a different directionality, the item in hand can be skipped, and moving ahead, the current contiguous span would end and a new span would begin starting at the next item. If the directionality of the next item is neutral, then the item in hand can be counted and the process moves ahead, but the current contiguous span would end, and a new span would begin. Effectively, this means that a neutral next item ends the current span without affecting the last item in hand, but an opposite directionality item would not only end the current span but also causes the discarding of the last item in hand. At each step, two different sums can be accumulated: a sum that is affected by contiguity (column #5 of FIG. 4), and an absolute sum (column #6 of FIG. 4), that is not affected by contiguity. The very last item in the series is never counted in because it has no next item and so its contiguity cannot be guaranteed.

With the above logic, the computation becomes as shown in the table in FIG. 4.

Referring to the table in FIG. 4, the consistency of the data set now becomes 1.24/4.92=25.2%. It is easy to see that evaluating the STIR/SHAKEN results by introducing the notions of frequency, recency, and contiguity yields more meaningful insights into what the data is actually indicating.

Consistency values derived from the historical STIR/SHAKEN data affect the trust that may be placed on the STIR/SHAKEN attestation & verstat values of the current call being risk assessed. A low consistency value from the past indicates that the corresponding trust in the current STIR/SHAKEN results should be adjusted accordingly.

In the above embodiments the data analytics algorithm that takes into consideration the totality of the STIR/SHAKEN data from the point of view of the entity that is consuming the attestation & verification status data provided by the Originating & Terminating Service Providers respectively. In additional embodiments, it can also be possible to analyze the STIR/SHAKEN data provided by the Originating Service Provider and the Terminating Service Provider individually without reference to each other. The algorithm described above remains unchanged, but the data that is analyzed is either just the attestation data or the verification data by themselves.

Effectively, this provides three (3) distinct analytics results: analytics from combined attestation & verstat values; analytics from attestation values alone; and analytics from verstat values alone.

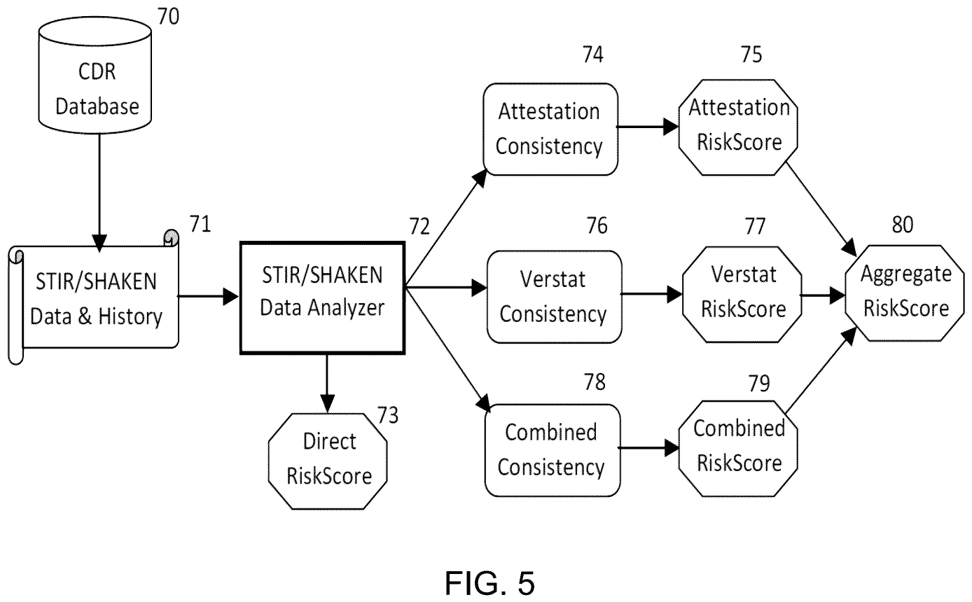

Depending on the solution's requirements, it is possible to weight the risk ratings computed from each of these 3 distinct analytics to arrive at a combined risk assessment of an inbound call. A system that implements the above process is shown in FIG. 5.

Referring to FIG. 5, the system includes:
CDR Database 70: Using the calling number present in the HTTP request, the STIR/SHAKEN history of the caller is retrieved from the CDR Database (70).
STIR/SHAKEN Data & History 71: The entire data consists of the STIR/SHAKEN data presented by the current inbound call along with the historical STIR/SHAKEN data for the calling number from the past up to a desired time period.
STIR/SHAKEN Data Analyzer 72: The STIR/SHAKEN Data Analyzer (72) within the SSAM then processes the STIR/SHAKEN history in several distinct passes.
Direct RiskScore 73: If there is absolutely no historical STIR/SHAKEN data, then the risk assessment is directly based on the STIR/SHAKEN data presented by the current inbound call. This is done as follows. If the result is Pass-A, return a risk score of 0. If result is Pass-B, return a risk score of 50. If the result is Pass-C, return a risk score of 80. If the result is Fail, then return a risk score of 100. The SSAM configuration may contain settings that can override these defaults.
Attestation Consistency 74: Only the attestation values of the historical STIR/SHAKEN data are analyzed as a data series with due consideration applied to frequency of values, recency, and contiguity, as described earlier.
Attestation RiskScore 75: The consistency rating of the Attestations is converted to a corresponding risk score. Since the consistency is the degree of trust in the data and is always in the range of −100→+100, the risk score is set as 100 for Consistency value of −100 and as 0 for Consistency value of +100, and varies linearly across the range of Consistency values.
Verstat Consistency 76: The verstat values of the historical STIR/SHAKEN data are analyzed as a data series with due consideration applied to frequency of values, recency, and contiguity, as described earlier.
Verstat RiskScore 77: The consistency rating of the verstat values is converted to a corresponding risk score. Since the consistency is the degree of trust in the data and is always in the range of −100→+100, the risk score is set as 100 for Consistency value of −100 and as 0 for Consistency value of +100, and varies linearly across the range of Consistency values.
Combined Consistency 78: The attestation & verstat values of the historical STIR/SHAKEN data pairs are first reduced to an enumeration of five effective resulting values as described previously and analyzed as a data series with due consideration applied to frequency of values, recency, and contiguity.
Combined RiskScore 79: The consistency rating of the blended attestion-verstat paired values is converted to a corresponding risk score. Since the consistency is the degree of trust in the data and is always in the range of −100→+100, the risk score is set as 100 for Consistency value of −100 and as 0 for Consistency value of +100, and varies linearly across the range of Consistency values.
Aggregate RiskScore 80: The Aggregate Risk Score from the SSAM analytics is computed by applying weight factors specified in the SSAM configuration as risk scoring parameters to each of the consistency ratings, namely those of attestations alone, verstats alone, and the blended attestation-verstat paired values, respectively.

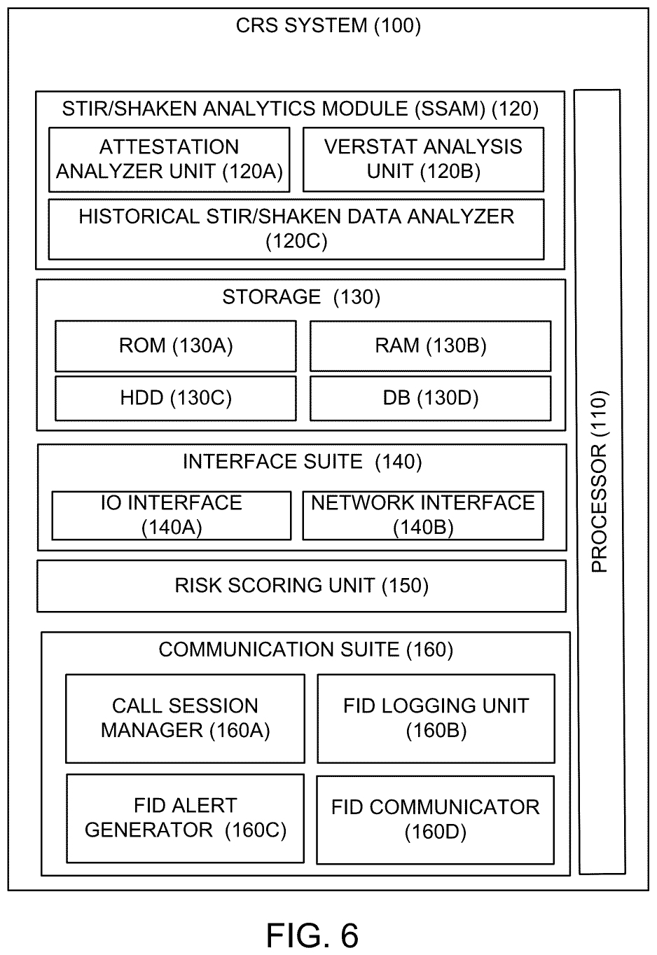

FIG. 6 shows a block diagram of a caller risk scoring (CRS) system 100, constructed according to the principles of the disclosure. The CRS system 100 can be included in at least one of a computing device, a communicating device, a server, a cloud network, or as a distributed system in any one or more of the foregoing. The CRS system 100 can include a processor 110, a STIR/SHAKEN analytics module (SSAM) 120, a storage 130, an interface suite 140, a risk scoring unit 150, and a communication suite 160. The CRS system 100 can include a bus (not shown), which can connect to each of, and facilitate communication and interaction between, any of the computer resource assets (or components) in the CRS system 100. The bus (not shown) can include any of several types of bus structures that may further interconnect to a memory bus (with or without a memory controller), a peripheral bus, and a local bus using any of a variety of commercially available bus architectures.

The processor 110 can include any of various commercially available processors, multi-core processors, microprocessors or multi-processor architectures.

The SSAM 120 can include a processor and a plurality of computer resources that are accessible and executable by the processor 110. In various non-limiting implementations, the computer resource assets in the SSAM 120 can be configured to be executable by the processor 110. The computer resources can be stored in and retrieved from, for example, the storage 130.

The CRS 120 can include a plurality of machine learning platforms, including one or more supervised machine learning systems and one or more unsupervised machine learning systems. The CRS 120 can include an attestation analyzer unit 120A configured to analyze received attestation data and a verstat analysis unit 120B configured to analyze received verstat data. The CRS 120 can include a historical STIR/SHAKEN data analyzer, which can communicate with the storage 130 (for example, database DB 130D) and receive historical data.

The SSAM 120 can include a non-transitory computer-readable storage medium that can hold executable or interpretable computer resources, including computer program code or instructions that, when executed by the processor 110, cause the steps, processes or methods in this disclosure to be carried out. The computer-readable storage medium can be contained in the storage 130.

The storage 130 can include a read-only memory (ROM) 130A, a random-access memory (RAM) 130B, a hard disk drive (HDD) 130C, and a database (DB) 130D. The storage 130, including computer-readable media, can be configured to provide nonvolatile storage of data, data structures, and computer-executable instructions (or computer program code). The storage 130 can accommodate the storage of any data in a suitable digital format. The storage 130 can include computing resources that can be used to execute aspects of the architecture included in the CRS system 100, including, for example, a program module, an application program, an application program interface (API), or program data.

In a non-limiting embodiment, the storage 130 can contain computer resources that are executable on the processor 110 to carry out the processes and functions disclosed herein. One or more of the computing resources can be cached in the RAM 130B as executable sections of computer program code or retrievable data.

In various embodiments, the computing resources can include an API such as, for example, a web API, a simple object access protocol (SOAP) API, a remote procedure call (RPC) API, a representation state transfer (REST) API, or any other utility or service API.

A basic input-output system (BIOS) can be stored in the non-volatile memory in the storage 130, such as, for example, the ROM 130A. The ROM 130A can include, a ROM, an erasable programmable read-only memory (EPROM), or an electrically erasable programmable read-only memory (EEPROM). The BIOS can contain the basic routines that help to transfer information between any one or more of the components in the CRS system 100 such as during start-up.

The RAM 130B can include a dynamic random-access memory (DRAM), a synchronous dynamic random-access memory (SDRAM), a static random-access memory (SRAM), a non-volatile random-access memory (NVRAM), or another high-speed RAM for caching data.

The HDD 130C can include, for example, an enhanced integrated drive electronics (EIDE) drive, a serial advanced technology attachments (SATA) drive, a solid state drive (SSD), or any suitable hard disk drive for use with big data. The HDD 130C can be configured for external use in a suitable chassis (not shown). The HDD 130C can be arranged to connect to the bus (not shown) via a hard disk drive interface (not shown).

The DB 130D can be arranged to be accessed by any one or more of the components in the CRS system 100, including the SSAM 120. The DB 130D can be arranged to receive a query and, in response, retrieve specific data, data records or portions of data records based on the query, including historical STIR/SHAKEN data. A data record can include, for example, a file or a log. The DB 130D can include a database management system (DBMS) that can interact with the components in the CRS system 100. The DBMS can include, for example, SQL, NoSQL, MySQL, Oracle, Postgress, Access, or Unix. The DB 130D can include a relational database.

The DB 130D can be configured to receive and store, for example, negative list records, speaker identification records, call duration, call start and end times, Internet Protocol (IP) addresses, media access control (MAC) addresses, ANIs, or and other call record (CR) data. The DB 130D can be arranged to store historical call data, including queries.

The interface suite 140 can include one or more input-output (IO) interfaces 140A and one or more network interfaces 140B. The interface suite 140 can be configured to receive, transmit or exchange data and command signals with any communicating device in the communication system or network.

The input-output (IO) interface 140A can be arranged to receive instructions or data from an operator. The IO interface 140A can be arranged to receive and transmit speech content, commands or data from (or to) an operator.

The IO interface 140A can be arranged to connect to or communicate with one or more input-output devices, including, for example, a keyboard, a mouse, a pointer, a stylus, a microphone, a speaker, an interactive voice response (IVR) unit, a graphic user interface (GUI), or a display device. The IO interface 140A can include a transmitter, a receiver or a transceiver. Signals, including speech content, can be received from any user device 10 in the communication system 1 via, for example, the IO interface 140A, and commands or data can be forwarded to any communicating device via the IO interface 140A or network interface 140B.

The IO interface 140A can include one or more audio drivers (not shown) and one or more video drivers (not shown). In various embodiments, the audio driver can include a sound card, a sound driver, an interactive voice response (IVR) unit, or any other device necessary to render a sound signal on a sound production device, such as for example, a speaker. The video driver can include a video card, a graphics driver, a video adaptor, or any other device necessary to render an image signal on a display device.

The network interface 140B can be arranged to connect to one or more communicating devices via the network, another communicating device or a call center. The network interface 140B can be arranged to connect to the Internet or any wired and/or wireless network. The network interface 140B can include a modem, a transmitter, a receiver or a transceiver. The network interface 140B can include a wired or a wireless communication network interface. When used in a local area network (LAN), the network interface 140B can be arranged to include a wired or wireless communication network interface that can connect to the LAN; and, when used in a wide area network (WAN), the network interface 140B can be arranged to include a modem to connect to the WAN network. The modem can be internal or external and wired or wireless. The modem can be connected to the bus via, for example, a serial port interface.

The risk scoring unit 150 is configured to interact with the SSAM 120 and calculate risk score for each incoming call, as discussed above. The risk scoring unit 150 can include a machine learning platforms, including one or more supervised machine learning systems and one or more unsupervised machine learning systems. The machine learning platform can include, for example, a neural network, a deep neural network, or the like.

The communication suite 160 can include a call session manager 160A, a fraud identification (FID) logging unit 160B, a FID alert generator 160C, and a FID communicator 160D, which can include one or more transceivers. Each transceiver can include a transmitter and a receiver arranged to transmit and receive communication signals, respectively. The communication signals can be configured for transmission via, for example, voice-over-Internet Protocol (VOIP), public switched telephone network (PSTN), cellular telephone network, or other communication media.

The call session manager 160A can be configured to interact with each communicating device in the communication system. The call session manager 160A can be configured to receive and transmit communication signals from/to any communicating device in the communication system. The call session manager 160A can be configured to analyze and log call-specific data for each call originating from a communicating device in the communication system.

The call session manager 160A can be configured to interact with, for example, the processor 100, the SSAM 120, the storage 130, and the FID logging unit 160B such that each incoming call can be analyzed and a risk score logged.

The FID logging unit 160B can be configured to interact with the SSAM 120 and, in response to attestation and verstat data analysis by units 120A and 120B, respectively, log details about the call, including any related call data.

The FID alert generator 160C can be configured to generate a risk score and send the risk score. The FID alert generator 160C can be further configured to generate a fraudster alert notification message based on the risk score.

The FID communicator 160D can be configured to send the risk score and/or the alert notification message to, for example, a call center or a communicating device in the communication system or network. The FID communicator 160D can be configured to packetize and transmit the alert notification message using a communication protocol compatible with the communication platform of the call center or communicating device, such as, for example, a communicating device in an enterprise communication system (for example, a communication system of an organization or other entity).

The terms “a,” “an,” and “the,” as used in this disclosure, means “one or more,” unless expressly specified otherwise.

The term “backbone,” as used in this disclosure, means a transmission medium or infrastructure that interconnects one or more computing devices or communication devices to provide a path that conveys data packets and instruction signals between the one or more computing devices or communication devices. The backbone can include a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The terms “communicating device” or “communication device,” as used in this disclosure, mean any computing device, hardware, or computing resource that can transmit or receive data packets, instruction signals or data signals over a communication link. The communicating device or communication device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, OG, 1G, 2G, 3G, 4G, 5G, or 6G cellular standards, satellite, or Bluetooth. A communication link can include, for example, an RS-232, RS-422, RS-485, or any other suitable interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a processor, a microprocessor (μC), a central processing unit (CPU), a graphic processing unit (GPU), a data processing unit (DPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICS, general purpose computers, super computers, personal computers, laptop computers, palmtop computers, notebook computers, desktop computers, workstation computers, or servers.

The terms “computer resource asset” or “computing resource asset,” as used in this disclosure, means a computing resource, a computing device or a communicating device, or any combination thereof.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, OG, 1G, 2G, 3G, 4G, 5G, or 6G cellular standards, or Bluetooth.

The terms “computer resource” or “computing resource,” as used in this disclosure, mean software, a software application, a web application, a web page, a computer application, a computer program, computer code, machine executable instructions, firmware, or a process that can be arranged to execute on a computing device or a communicating device.

The terms “computer resource process” or “computing resource process,” as used in this disclosure, mean a computing resource that is in execution or in a state of being executed on an operating system of a computing device, such as, for example, the processor 110 (shown in FIG. 6). Each computing resource that is created, opened, or executed on or by the operating system can create a corresponding computing resource process. A computing resource process can include one or more threads, as will be understood by those skilled in the art.

The term “database,” as used in this disclosure, means any combination of software or hardware, including at least one computing resource or at least one computer. The database can include a structured collection of records or data organized according to a database model, such as, for example, but not limited to at least one of a relational model, a hierarchical model, or a network model. The database can include a database management system application (DBMS). The at least one application may include, but is not limited to, a computing resource such as, for example, an application program that can accept connections to service requests from communicating devices by sending back responses to the devices. The database can be configured to run the at least one computing resource, often under heavy workloads, unattended, for extended periods of time with minimal or no human direction.

The terms “including,” “comprising” and variations thereof, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or the like, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software or hardware, including at least one computing resource or at least one computer to perform services for connected communicating devices as part of a client-server architecture. The at least one server application can include, but is not limited to, a computing resource such as, for example, an application program that can accept connections to service requests from communicating devices by sending back responses to the devices. The server can be configured to run the at least one computing resource, often under heavy workloads, unattended, for extended periods of time with minimal or no human direction. The server can include a plurality of computers configured, with the at least one computing resource being divided among the computers depending upon the workload. For example, under light loading, the at least one computing resource can run on a single computer. However, under heavy loading, multiple computers can be required to run the at least one computing resource. The server, or any if its computers, can also be used as a workstation.

The terms “transmission,” “transmit,” or “send,” as used in this disclosure, mean the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include air, coaxial cables, copper wire, or fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A method for determining caller risk scoring using STIR/SHAKEN data, the method comprising:
receiving, by a fraud detection engine, STIR/SHAKEN attestation and verification status data associated with an inbound call from a real-time telephony network signaling system;
retrieving, by the fraud detection engine, historical STIR/SHAKEN data associated with a calling number from a call authentication database;
categorizing attestation-verification pairings into a predefined set of resolved values comprising Pass-A, Pass-B, Pass-C, Fail, and None;
computing a consistency rating for the calling number by applying weighting factors to the attestation and verification data based on at least one of:
a frequency of prior occurrences,
a recency-based decay factor applied to historical data, and
a contiguity analysis of directionally similar attestation-verification pairings; and
determining a caller risk score for the inbound call based on the computed consistency rating; and
outputting the caller risk score to a service platform for call treatment.

2. The method of claim 1, further comprising applying an appropriate decay function for computing the weight factors to be applied to the historical STIR/SHAKEN data to allow for higher significance to recent STIR/SHAKEN data and lesser significance to remote STIR/SHAKNE data, wherein the decay function is selected from a built-in set of decay functions to choose from, including a Null Decay Function, a Linear Decay Function, a Stepped Decay Function, a Geometric Decay Function, and a Power Decay Function.

3. The method of claim 1, further comprising adjusting the caller risk score based on a dynamic fraud intelligence feed.

4. The method of claim 1, further comprising assigning a higher weight to contiguous spans of directionally similar attestation-verification values when computing the consistency rating.

5. The method of claim 1, wherein the predefined set of resolved values is computed by mapping each attestation-verification pairing to a corresponding numeric value, and assigning a weight to the numeric value based on its position within the set of historical numeric values, the computation of the weight being done using an appropriately chosen decay function.

6. The method of claim 1, further comprising storing the computed caller risk score in a database for future reference.

7. The method of claim 1, wherein the caller risk score is transmitted to a third-party fraud prevention service for call handling.

8. A system for caller risk scoring using STIR/SHAKEN data, the system comprising:
a processor configured to:
receive STIR/SHAKEN attestation and verification status data associated with an inbound call;
retrieve historical STIR/SHAKEN data associated with a calling number;
categorize attestation-verification pairings into a predefined set of resolved values comprising Pass-A, Pass-B, Pass-C, Fail, and None;
compute a consistency rating for the calling number by applying weighting factors to the attestation and verification data based on at least one of
a frequency of prior occurrences,
a recency-based decay factor applied to historical data, and
a contiguity analysis of directionally similar attestation-verification pairings;
determine a caller risk score for the inbound call based on the computed consistency rating; and
output the caller risk score for application to call handling policies; and
a storage medium storing historical STIR/SHAKEN data and attestation-verification pairings; and
a communication interface configured to transmit the caller risk score to at least one service provider.

9. The system of claim 8, wherein the processor is further configured to:
select an appropriate decay function from a set of built-in decay functions within a STIR/SHAKEN analytics module (SSAM); and
apply the decay function as the recency-based decay adjustment to historical STIR/SHAKEN data values.

10. The system of claim 8, wherein the processor is further configured to adjust the caller risk score based on a real-time fraud intelligence feed.

11. The system of claim 8, wherein the processor is further configured to assign a higher weight to contiguous spans of directionally similar attestation-verification values when computing the consistency rating.

12. The system of claim 8, wherein the processor is further configured to map each attestation-verification pairing to a corresponding risk weight based on predefined threshold values.

13. The system of claim 8, wherein the storage medium stores previously computed caller risk scores for future reference.

14. The system of claim 8, wherein the communication interface is configured to transmit the computed caller risk score to a fraud detection service for call treatment.

15. A non-transitory computer-readable medium storing instructions that, when executed by a processor, cause a computing device to perform operations comprising:
receiving STIR/SHAKEN attestation and verification status data associated with an inbound call;
retrieving historical STIR/SHAKEN data associated with a calling number;
categorizing attestation-verification pairings into a predefined set of resolved values comprising Pass-A, Pass-B, Pass-C, Fail, and None;
computing a consistency rating for the calling number by applying weighting factors to the attestation and verification data based on at least one of:
a frequency of prior occurrences,
a recency-based decay factor applied to historical data, and
a contiguity analysis of directionally similar attestation-verification pairings;
determining a caller risk score for the inbound call based on the computed consistency rating; and
outputting the caller risk score to a service platform for call treatment.

16. The non-transitory computer-readable medium of claim 15, wherein the instructions cause the computing device to:
select an appropriate decay function from a set decay functions in a STIR/SHAKEN analytics module (SSAM); and
apply the decay function as the recency-based decay adjustment to historical STIR/SHAKEN data values.

17. The non-transitory computer-readable medium of claim 15, wherein the instructions cause the computing device to adjust the caller risk score based on real-time fraud intelligence data.

18. The non-transitory computer-readable medium of claim 15, wherein the instructions cause the computing device to assign a higher weight to contiguous spans of directionally similar attestation-verification values when computing the consistency rating.

19. The non-transitory computer-readable medium of claim 15, wherein the instructions cause the computing device to store computed caller risk scores for future reference.

20. The non-transitory computer-readable medium of claim 15, wherein the instructions cause the computing device to transmit the computed caller risk score to a fraud prevention system for call handling.
